(19) United States
(12) Patent Application Publication
(10) Pub. No.: US 2016/0267118 A1
(43) Pub. Date: Sep. 15, 2016

(54) INFORMATION BEARING DEVICES AND AUTHENTICATION DEVICES INCLUDING SAME

(71) Applicant: POLLY INDUSTRIES LIMITED, Kwun Tong, Kowloon Hong Kong (CN)

(72) Inventors: Tak Wai LAU, Kowloon, Hong Kong (CN); Wing Hong LAM, Kowloon, Hong Kong (CN)

(21) Appl. No.: 15/032,389

(22) PCT Filed: Oct. 28, 2014
(86) PCT No.: PCT/IB2014/065654

§ 371 Date: Apr. 27, 2016

(30) Foreign Application Priority Data
Oct. 28, 2013 (HK) 13112108.9

(51) Int. Cl. G06F 17/30; G06F 17/16; G06F 21/44

(52) U.S. Cl. CPC G06F 17/30333; G06F 21/44; G06F 17/16

(57) ABSTRACT

An information bearing device comprising a data bearing pattern, the data bearing pattern comprising M×N pattern defining elements which are arranged to define a set of characteristic spatial distribution properties (Î_{u,v}^{M,N}(x,y)), wherein the set of data comprises a plurality of discrete data and each said discrete data (uᵢ,vᵢ) has an associated data bearing pattern which is characteristic of said discrete data, and the set of characteristic spatial distribution properties is due to the associated data bearing patterns of said plurality of discrete data, wherein said discrete data and the associated data bearing pattern of said discrete data is related by a characteristic relation function (βₖ_{₁}_{,}^{u}^{ᵢ}^{,v}^{ᵢ}(x,y), the characteristic relation function defining spatial distribution properties of said associated data bearing pattern according to said discrete data (uᵢ,vᵢ) and a characteristic parameter (k) that is independent of said discrete data.

### FIELD

The present invention relates to information bearing devices and authentication devices comprising same.

### BACKGROUND

Information bearing device are widely used to carry coded or un-coded embedded messages. Such messages may be used for delivering machine readable information or for performing security purposes such as for combatting counterfeiting. Many known information bearing devices containing embedded security messages are coded or encrypted using conventional schemes and such coding or encryption schemes can be easily reversed once the coding or encryption schemes are known.

### SUMMARY

An information bearing device comprising a data bearing pattern has been disclosed. The data bearing pattern comprises M×N pattern defining elements which are arranged to define a set of characteristic spatial distribution properties (Îᵤᵥ^{M,N}(x,y)). The set of data comprises a plurality of discrete data and each said discrete data (uᵢ,vᵢ) has an associated data bearing pattern which is characteristic of said discrete data, and the set of characteristic spatial distribution properties is due to the associated data bearing patterns of said plurality of discrete data. Said discrete data and the associated data bearing pattern of said discrete data is related by a characteristic relation function (βₖ_{₁}_{,k}_{₂}^{u}^{ᵢ}^{,v}^{ᵢ}(x,y). The characteristic relation function defining spatial distribution properties of said associated data bearing pattern according to said discrete data (uᵢ,vᵢ) and a characteristic parameter (k) that is independent of said discrete data.

In some embodiments, the data bearing pattern comprises M×N pattern defining elements which are arranged to define a set of characteristic spatial distribution properties (Î_{u,v}^{M,N}(x,y)). The set of data comprises at least one discrete data (uᵢ,vᵢ). Said discrete data has an associated data bearing pattern which is characteristic of said discrete data. Said discrete data and the associated data bearing pattern of said discrete data is related by a characteristic relation function (βₖ_{₁}_{,k}_{₂}^{u}^{ᵢ}^{,v}^{ᵢ}(x,y). The characteristic relation function defines spatial distribution properties of said associated data bearing pattern according to said discrete data (uᵢ,vᵢ) and a characteristic parameter (k) that is independent of said discrete data.

In some embodiments, the data bearing pattern comprises pattern defining elements arranged into M rows along a first spatial direction (x) and N columns along a second spatial direction (y). The relation function (βₖ_{₁}_{,k}_{₂}^{u}^{ᵢ}^{,v}^{ᵢ}(x,y)) may have a monotonous trend of change of spatial distribution properties in each spatial direction.

In some embodiments, the set of data comprises a plurality of discrete data and the relation functions ([βₖ^{u,v}(x,y)]) of said plurality of discrete data are linearly independent.

There is disclosed a method of forming an information bearing device, the information bearing device comprising a data bearing pattern having a set of characteristic spatial distribution properties (Î_{u,v}^{M,N}(x,y)). The method comprises processing a set of data comprising a plurality of discrete data by a corresponding plurality of relation functions ([βₖ^{u,v}(x,y)]) to form the data bearing pattern, wherein the relation functions are linearly independent and each relation function (βₖ_{₁}_{,k}_{₂}^{u}^{ᵢ}^{,v}^{ᵢ}(x,y)) relates a discrete data (uᵢ,vᵢ) to an data bearing pattern having a set of spatial distribution properties characteristic of said discrete data. The spatial distribution characteristics of said data bearing pattern is dependent on a characteristic parameter that is independent of said discrete data.

In some embodiments, the data bearing pattern comprises M×N pattern defining elements and the method comprises including a maximum of M×N relation functions [βₖ^{u,v}(x,y)] to define a maximum of M×N data bearing patterns to form said data bearing pattern, wherein each one of said the M×N data bearing patterns has a set of characteristic spatial distribution properties that is specific to said discrete data (uᵢ,vᵢ).

### FIGURES

The disclosure will be described by way of example with reference to the accompanying Figures, in which:

FIG. 1 shows an example information bearing device according to the disclosure,

FIG. 1A shows an example information bearing device according to the disclosure,

FIG. 1B shows an example information bearing device according to the disclosure,

FIG. 1C shows an example information bearing device according to the disclosure,

FIG. 2 shows an example information bearing device according to the disclosure,

FIG. 2A shows an example information bearing device according to the disclosure,

FIG. 2B shows an example information bearing device according to the disclosure,

FIG. 3 shows an example information bearing device according to the disclosure,

FIG. 4 shows an example information bearing device according to the disclosure,

FIG. 5 shows an example information bearing device according to the disclosure,

FIG. 6 shows an example information bearing device according to the disclosure, and

FIG. 7 shows an example information bearing device according to the disclosure.

### DESCRIPTION

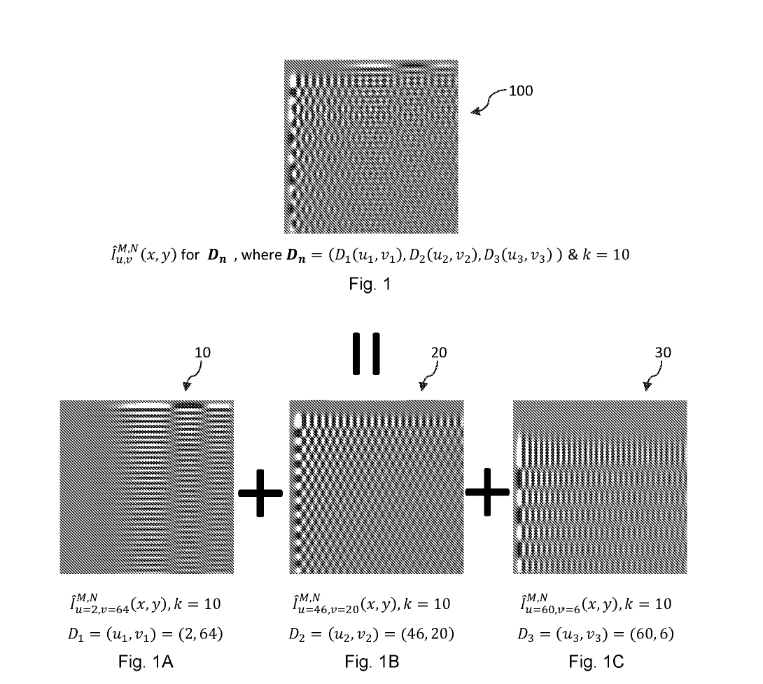

An example information bearing device depicted in FIG. 1 comprises a data bearing pattern 100. The data bearing pattern 100 comprises (N×M) pattern defining elements which are arranged in a display matrix comprising N rows and M columns of pixels or pixel elements, where N=M=256 in this example. Each pixel element can be 8-bit grey-scale coded to have a maximum of 256 grey levels, ranging from 0-255. This data bearing pattern has been encoded with an example set of data Dₙ, where n represents the number of discrete data which is 3 in the present example, and D, comprises D₁, D₂, D₃. Each of the discrete data D₁, D₂, D₃ comprises a two-dimensional variable (uᵢ,vᵢ) having a first component (uᵢ or ‘u’-component) in a first axis, say u-axis and a second component (vᵢ or ‘v’-component) in a second axis, say v-axis, the second axis being orthogonal to the first axis.

Each discrete data may be represented by the mathematical expression below,

$${D}_{i} ( u , v ) = \{ \begin{matrix}{A}_{i} & u = {u}_{i} and v = {v}_{i} \\ 0 & otherwise\end{matrix} ,$$

where

Aᵢ is an amplitude parameter representing intensity strength of the data. The values of Aᵢ may be adjusted for each discrete data without loss of generality and are set to 1 as a convenient example. Each discrete data D₁ may be denoted by its components uᵢ,vᵢ in the data domain and the example discrete data have the following example values:

| Dᵢ | D₁ | D₂ | D₃ |
|---|---|---|---|
| (uᵢ, vᵢ) | (2, 64) | (46, 20) | (60, 6) |

The example data bearing pattern 100 can be regarded as a linear combination or a linear superimposition of three data bearing patterns. The three data bearing patterns are respectively due to D₁,D₂,D₃ and the data bearing patterns due to the individual data D₁, D₂, D₃ are depicted respectively in FIGS. 1A, 1B and 10.

The data bearing pattern 10 of FIG. 1A is due to data D₁. This data bearing pattern 10 is representable by an expression Îᵤ_{₁}_{,v}_{₁}^{M,N}(x,y), where u₁ and v₁ are component values of D₁ expressible as a two-dimensional data (u₁,v₁). In this example, u₁=2, v₁=64 and an expression Î_{u1,v1}^{M,N}(x,y) contains unique spatial distribution properties of the data bearing pattern 10 in the form of grey-level of each pixel element in the matrix of (N×M) pixel elements.

The relationship between the spatial image expression Î_{u,v}^{M,N}(x,y) and a set of data, D comprising an integer of n discrete 2-dimensional data, namely, D=((u₁,v₁), (u₂,v2₁), . . . , (uₙ,vₙ)) can be generally expressed as follows:

Î_{u,v}^{M,N}(x,y)=Σᵤ₌₁^{N}Σᵥ₌₁^{N}Σₖ^{u,v}(x,y){ΣᵢDᵢ(u,v)} (E100)

Where βₖ^{u,v}(x,y) is a relation function relating the discrete data (uᵢ,vᵢ) to a set of spatial distribution properties as defined by the spatial image expression Î_{u,v}^{M,N}(x,y) and the spatial distribution properties are further determined by the parameter k.

For the example device of FIG. 1, a modified Bessel function of order k as below is used as an example relation function:—

$${β}_{k}^{u , v} ( x , y ) = \frac{4}{{α}_{k , M + 1} {α}_{k , N + 1}} \frac{{J}_{k} ( \frac{{α}_{k , u} {α}_{k , x}}{{α}_{k , M + 1}} ) {J}_{k} ( \frac{{α}_{k , v} {α}_{k , y}}{{α}_{k , N + 1}} )}{\vert {J}_{k + 1} ( {α}_{k , u} ) \vert \vert {J}_{k + 1} ( {α}_{k , x} ) \vert \vert {J}_{k + 1} ( {α}_{k , v} ) \vert \vert {J}_{k + 1} ( {α}_{k , y} ) \vert} ,$$

where

$${J}_{k} ( \frac{{α}_{k , u} {α}_{k , x}}{{α}_{k , M + 1}} )$$

is an elementary relation function for variable x and has a predetermined key k, where x=1 to M,

$${J}_{k} ( \frac{{α}_{k , v} {α}_{k , y}}{{α}_{k , N + 1}} )$$

is an elementary relation function for variable y having the same key k, where y=1 to N, and

$${J}_{k} ( r ) = {\sum }_{i = 0}^{∞} \frac{{( - 1 )}^{i}}{i ! Γ ( i + k + 1 )} {( \frac{r}{2} )}^{2 i + k}$$

is a Bessel function of the first kind, α_{k,i} being the i-th root of Bessel function of the first kind of order k, and Γ is a gamma function.

Where there is a single discrete data (uᵢ,vᵢ), the expression Îᵤ_{ᵢ}_{,v}_{ᵢ}^{M,N}(x,y) above will boil down to a single relation function βₖ^{u}^{ᵢ}^{,v}^{ᵢ}(x,y) having properties distributed in two spatial dimensions, namely, ‘x-’ dimension and ‘y-’ dimension. Therefore, for each single discrete data (uᵢ,vᵢ), there is a corresponding characteristic function with properties or characteristics of which are spread, scattered or distributed throughout or around the data bearing pattern 100 which comprises N×M image defining elements. As each expression βₖ^{u}^{ᵢ}^{,v}^{ᵢ}(x,y) is characteristic or definitive of the spatial properties of an data bearing pattern corresponding to a single discrete data (uᵢ,vᵢ), βₖ^{u}^{ᵢ}^{,v}^{ᵢ}(x,y) can be considered as a characteristic two-dimensional relation function relating or co-relating a single discrete data to an image pattern having a set of spatial distribution properties. Spatial distribution properties in the present context includes spatial variation properties between adjacent pixel elements, including separation between adjacent peak and trough coded pixel elements, separation between adjacent peak and peak and/or trough and trough coded pixel elements, trend of changes of pixel coding between adjacent peak and trough coded pixel elements, and other spatial properties. For example, where pixel elements are coded in grey scales, the coding will appear as intensity amplitude distribution. Where pixel elements are coded in colour, the coding will appear as different colours. A combination of colour and grey scale coding may be used without loss in generality.

As there is a characteristic two-dimensional (‘2-D’) relation function βₖ^{u}^{ᵢ}^{,v}^{ᵢ}(x,y) corresponding to each single discrete data (uᵢ,vᵢ), and each characteristic two-dimensional function βₖ^{u}^{ᵢ}^{,v}^{ᵢ}(x,y) corresponds to an image pattern, it follows that each single discrete data has a corresponding image pattern. Where the two-dimensional relation functions βₖ^{u}^{ᵢ}^{,v}^{ᵢ}(x,y) are unique, no two relation functions will be identical, the image patterns are all unique and each image pattern has a specific corresponding correlation to a discrete data will have a unique correspondence with a corresponding data. As there are a total of N×M characteristic two-dimensional relation functions βₖ^{u,v}(x,y), a maximum of N×M discrete data can be represented by the image pattern corresponding to the expression Î_{u,v}^{M,N}(x,y).

Where the characteristic two-dimensional relation functions βₖ^{u,v}(x,y) have linear independence or are linearly independent, each single discrete data has a specific, unique or singular corresponding image pattern. With the relation functions βₖ^{u,v}(x,y) being linearly independent, the image pattern as represented by the expression Î_{u,v}^{M,N}(x,y) can represent a maximum of N×M different discrete data.

The set of N×M relation functions comprises the following individual 2-D relation functions which are linearly independent:—

{βₖ^{1,1}(x,y),βₖ^{1,2}(x,y), . . . ,βₖ^{1,N}(x,y),βₖ^{2,1}(x,y),βₖ^{2,2}(x,y), . . . ,βₖ^{2,N}(x,y), . . . ,βₖ^{M,1}(x,y),βₖ^{M,2}(x,y), . . . ,βₖ^{M,N}(x,y)}

Linearly independence of the 2-D relation functions βₖ^{u,v}(x,y) means that the 2-D relation functions βₖ^{u,v}(x,y) satisfy the following relationship:

Σᵤ₌₁^{M}Σᵥ₌₁^{N}a_{u,v}βₖ^{u,v}(x,y)=0 if and only if α_{1,1}=α_{1,2}= . . . =α_{M,N}=0

The 2-D relation functions βₖ^{u,v}(x,y) can be expressed as a product of two (one dimensional) 1-D elementary relation functions εₖ^{u}(x) and εₖ^{v}(y) such that βₖ^{u,v}(x,y)=εₖ^{u}(x)εₖ^{v}(y), in which for the example of FIG. 1 (altered Bessel function):—

$${ɛ}_{k}^{u} ( x ) = \frac{2 {J}_{k} ( \frac{{α}_{k , u} {α}_{k , x}}{{α}_{k , M}} )}{{α}_{k , M} \vert {J}_{k + 1} ( {α}_{k , u} ) \vert \vert {J}_{k + 1} ( {α}_{k , x} ) \vert}$$

$$and$$

$${ɛ}_{k}^{v} ( y ) = \frac{2 {J}_{k} ( \frac{{α}_{k , v} {α}_{k , y}}{{α}_{k , N}} )}{{α}_{k , N} \vert {J}_{k + 1} ( {α}_{k , v} ) \vert \vert {J}_{k + 1} ( {α}_{k , y} ) \vert}$$

The 1-D elementary relation functions εₖ^{u}(x) and εₖ^{v}(y) are also linearly independent and satisfy the following relationships:

α₁εₖ^{u=1}(x)+α₂εₖ^{u=2}(x)+ . . . +α_{M}εₖ^{u=M}(x)=0 if and only if α₁=α₂= . . . =α_{M}=0

and

a₁εₖ^{v=1}(y)+a₂εₖ^{v=2}(y)+ . . . +a_{N}εₖ^{v=N}(y)=0 if and only if α₁=α₂= . . . =α_{N}=0.

The relationship between the image pattern Î_{u,v}^{M,N}(x,y) and data, D can be expressed in matrix form as follows:

Î_{u,v}^{M,N}(x,y)= [symbol] (u,x)Î_{x,y}^{M,N}(u,v) [symbol] (v,y), (E120)

Where Î_{x,y}^{M,N}(u,v) is a representation of the data, D, using data domain variables u, v,

$$( u , x ) = [ \begin{matrix}{ɛ}_{k} ( u = 1 , x = 1 ) & … & {ɛ}_{k} ( u = 1 , x = M ) \\ ⋮ & ⋱ & ⋮ \\ {ɛ}_{k} ( u = M , x = 1 ) & … & {ɛ}_{k} ( u = M , x = M )\end{matrix} ] , \\ and$$

$$( v , y ) = [ \begin{matrix}{ɛ}_{k} ( v = 1 , y = 1 ) & … & {ɛ}_{k} ( v = 1 , y = N ) \\ ⋮ & ⋱ & ⋮ \\ {ɛ}_{k} ( v = N , y = 1 ) & … & {ɛ}_{k} ( v = N , y = N )\end{matrix} ] .$$

The 1-D elementary relation functions εₖ^{u}(x)&εₖ^{v}(y) in each column of same x value or each column of same y value, are linearly independent.

For computational efficiency, [symbol] (u,x) when arranged in matrix form comprises the following column vectors of same x values and row vector of same u values:—

$$\{ ( \begin{matrix}{ɛ}_{k} ( u = 1 , x = 1 ) \\ ⋮ \\ {ɛ}_{k} ( u = M , x = 1 )\end{matrix} ) , ( \begin{matrix}{ɛ}_{k} ( u = 1 , x = 2 ) \\ ⋮ \\ {ɛ}_{k} ( u = M , x = 2 )\end{matrix} ) , … , ( \begin{matrix}{ɛ}_{k} ( u = 1 , x = M ) \\ ⋮ \\ {ɛ}_{k} ( u = M , x = M )\end{matrix} ) \}$$

In the above matrix, the set of column vectors are linear independent, which means:

$${c}_{1} ( \begin{matrix}{ɛ}_{k} ( 1 , 1 ) \\ ⋮ \\ {ɛ}_{k} ( M , 1 )\end{matrix} ) + {c}_{2} ( \begin{matrix}{ɛ}_{k} ( 1 , 2 ) \\ ⋮ \\ {ɛ}_{k} ( M , 2 )\end{matrix} ) + … + {c}_{M - 1} ( \begin{matrix}{ɛ}_{k} ( 1 , M ) \\ ⋮ \\ {ɛ}_{k} ( M , M )\end{matrix} ) = 0$$

if and only if c₁=c₂= . . . =C_{M}=0, and

a₁εₖ(1,x)+a₂εₖ(2,x)+ . . . +a_{M}εₖ(M,x)=0 if and only if a₁=a₂= . . . =a_{M}=0.

Likewise, [symbol] (v,y) when arranged in matrix form comprises the following column vectors of same y values and row vectors of same v values:

$$\{ ( \begin{matrix}{ɛ}_{k} ( v = 1 , y = 1 ) \\ ⋮ \\ {ɛ}_{k} ( v = N , y = 1 )\end{matrix} ) , ( \begin{matrix}{ɛ}_{k} ( v = 1 , y = 2 ) \\ ⋮ \\ {ɛ}_{k} ( v = N , y = 2 )\end{matrix} ) , … , ( \begin{matrix}{ɛ}_{k} ( v = 1 , y = N ) \\ ⋮ \\ {ɛ}_{k} ( v = N , y = N )\end{matrix} ) \}$$

The column vectors of [symbol] (v,y) are also linearly independent.

Linear independence of the column vectors in the matrix expressions above means that every spatial image Î_{x,y}^{M,N}(u,v) having the above relationship would correspond to a unique data set D, and the corresponding unique data set in representation Î_{x,y}^{M,N}(u,v) can be recovered by an inverse transform, for example, by reversing the relationship of E120 above as below:

Î_{x,y}^{M,N}(u,v)= [symbol] (u,x)Î_{u,v}^{M,N}(x,y) [symbol] (v,y) E140

For example, where a plurality of discrete data is embedded in an image pattern Î_{u,v}^{M,N}(x,y), the plurality of discrete data can be recovered by performing the following inverse transformation:

$${\sum }_{i} {D}_{i} ( u , v ) = \frac{4}{{α}_{k , M + 1} {α}_{k , N + 1}} {\sum }_{x = 1}^{M} {\sum }_{y = 1}^{N} \frac{{J}_{k} ( \frac{{α}_{k , u} {α}_{k , x}}{{α}_{k , M + 1}} ) {J}_{k} ( \frac{{α}_{k , v} {α}_{k , y}}{{α}_{k , N + 1}} )}{\vert {J}_{k + 1} ( {α}_{k , u} ) \vert \vert {J}_{k + 1} ( {α}_{k , x} ) \vert \vert {J}_{k + 1} ( {α}_{k , v} ) \vert \vert {J}_{k + 1} ( {α}_{k , y} ) \vert} \{ {\hat{I}}_{u , v}^{M , N} ( x , y ) \}$$

To further enhance computational efficiency, the relation functions are mutually orthogonal, in which case the 2-D relation functions βₖ^{u,v}(x,y) has the following characteristics:

$${\sum }_{x = 1}^{M} {\sum }_{y = 1}^{N} {β}_{k}^{u , v} ( x , y ) {β}_{k}^{u , v} ( {x}^{′} , {y}^{′} ) = \{ \begin{matrix}1 & if x = {x}^{′} and y = {y}^{′} \\ 0 & otherwise\end{matrix}$$

In addition, the 1-D elementary relation functions εₖ^{u}(x)&εₖ^{v}(y) will have the following orthogonal characteristics:

$${\sum }_{u = 1}^{M} {ɛ}_{k} ( u , x ) {ɛ}_{k} ( u , {x}^{′} ) = \{ \begin{matrix}1 & x = {x}^{′} \\ 0 & if x = {x}^{′}\end{matrix}$$

Where the relation functions are orthogonal, the forward and inverse transformations Î_{u,v}^{M,N}(x,y) and Î_{x,y}^{M,N}(u,v) conserve total intensity.

In some embodiments, the 1-D elementary relation functions εₖ^{u}(x) and εₖ^{v}(y) may have different key parameters, k. For example, εₖ^{u}(x) has k=k₁ and εₖ^{u}(y) has k=k₂, in which case the set of discrete data may be recovered from an inverse transformation having the following expression:

$${\sum }_{i} {D}_{i} ( u , v ) = \frac{4}{{α}_{k 1 , M + 1} {α}_{k 2 , N + 1}} {\sum }_{x = 1}^{M} {\sum }_{y = 1}^{N} \frac{{J}_{k 1} ( \frac{{α}_{k 1 , u} {α}_{k 1 , x}}{{α}_{k 1 , M + 1}} ) {J}_{k 2} ( \frac{{α}_{k 2 , v} {α}_{k 2 , y}}{{α}_{k 2 , N + 1}} )}{\vert {J}_{k + 1} ( {α}_{k 1 , u} ) \vert \vert {J}_{k 1 + 1} ( {α}_{k 1 , x} ) \vert \vert {J}_{k 2 + 1} ( {α}_{k 2 , v} ) \vert \vert {J}_{k 2 + 1} ( {α}_{k 2 , y} ) \vert} \{ {\hat{I}}_{u , v}^{M , N} ( x , y ) \}$$

In an example, the set of data D comprises a single discrete data D₁ only, with D₁=(u₁,v₁)=(2,64), the representation Î_{u,v}^{M,N}(x,y) will become Î_{u1,v1}^{M,N}(x,y)=Î_{2,64}^{M,N}(x,y) and the expression:

$${\hat{I}}_{u , v}^{M , N} ( x , y ) = {\sum }_{u = 1}^{M} {\sum }_{v = 1}^{N} {β}_{k}^{u , v} ( x , y ) \{ {\sum }_{i} {D}_{i} ( u , v ) \}$$

will become:

$$\begin{matrix}{\hat{I}}_{u = 2 , v = 64}^{M , N} ( x , y ) = {\sum }_{u = 1}^{M} {\sum }_{v = 1}^{N} {β}_{k}^{u , v} ( x , y ) \{ {D}_{1} ( u , v ) \} \\ = {β}_{k}^{2 , 64} ( x , y ) \\ = {G}_{k}^{2 , 64} ( x , y ) {J}_{k} ( \frac{{α}_{k , 2} {α}_{k , x}}{{α}_{k , 257}} ) {J}_{k} ( \frac{{α}_{k , 64} {α}_{k , y}}{{α}_{k , 257}} )\end{matrix}$$

$$where {G}_{k}^{2 , 64} ( x , y ) = \frac{4}{{α}_{k , 257} {α}_{k , 257} \vert {J}_{k + 1} ( {α}_{k , 2} ) \vert \vert {J}_{k + 1} ( {α}_{k , x} ) \vert \vert {J}_{k + 1} ( {α}_{k , 64} ) \vert \vert {J}_{k + 1} ( {α}_{k , y} ) \vert}$$

is a normalising factor, and where

$${J}_{k} ( r ) = {\sum }_{i = 0}^{∞} \frac{{( - 1 )}^{i}}{i ! Γ ( i + k + 1 )} {( \frac{r}{2} )}^{2 i + k}$$

and α_{k,j} is a root of Bessel function and k is order of the Bessel function.

Therefore, the data bearing pattern 10 of FIG. 1A as represented by the expression Î_{u2,v=64}^{M,N}(x,y) has a unique corresponding representation in the form of:

$${G}_{k}^{2 , 64} ( x , y ) {J}_{k} ( \frac{{α}_{k , 2} {α}_{k , x}}{{α}_{k , 257}} ) {J}_{k} ( \frac{{α}_{k , 64} {α}_{k , y}}{{α}_{k , 257}} )$$

for k=10.

Similarly, where the set of data D comprises a single discrete data D₂ and D₂=(u₂,v₂)=(46, 20), the representation Î_{u,v}^{M,N}(x,y) of the data bearing pattern 20 of FIG. 1B will become Î_{u2,v2}^{M,N}(x,y)=Î_{46,20}^{M,N}(x,y) and the unique corresponding representation will be in the form of

$${G}_{k}^{46 , 20} ( x , y ) {J}_{k} ( \frac{{α}_{k , 46} {α}_{k , x}}{{α}_{k , 257}} ) {J}_{k} ( \frac{{α}_{k , 20} {α}_{k , y}}{{α}_{k , 257}} )$$

for k=10.

Likewise, where the set of data D comprises a single discrete data D₃ and D₃=(u₃,v₃)=(60, 6), the representation Î_{u,v}^{M,N}(x,y) of the data bearing pattern 30 of FIG. 1C will become Î_{u3,v3}^{M,N}(x,y)=Î_{60,6}^{M,N}(x,y) and the unique corresponding representation will be in the form of

$${G}_{k}^{60 , 6} ( x , y ) {J}_{k} ( \frac{{α}_{k , 60} {α}_{k , x}}{{α}_{k , 257}} ) {J}_{k} ( \frac{{α}_{k , 6} {α}_{k , y}}{{α}_{k , 257}} )$$

for k=10.

Where the set of data D comprises 3 discrete data, namely, D=(D₁, D₂, D₃), the expression Î_{u,v}^{M,N}(x,y) of the data bearing pattern 100 of FIG. 1 is due to the sum of the three corresponding expressions of the individual data, namely, D₁, D₂, and D₃.

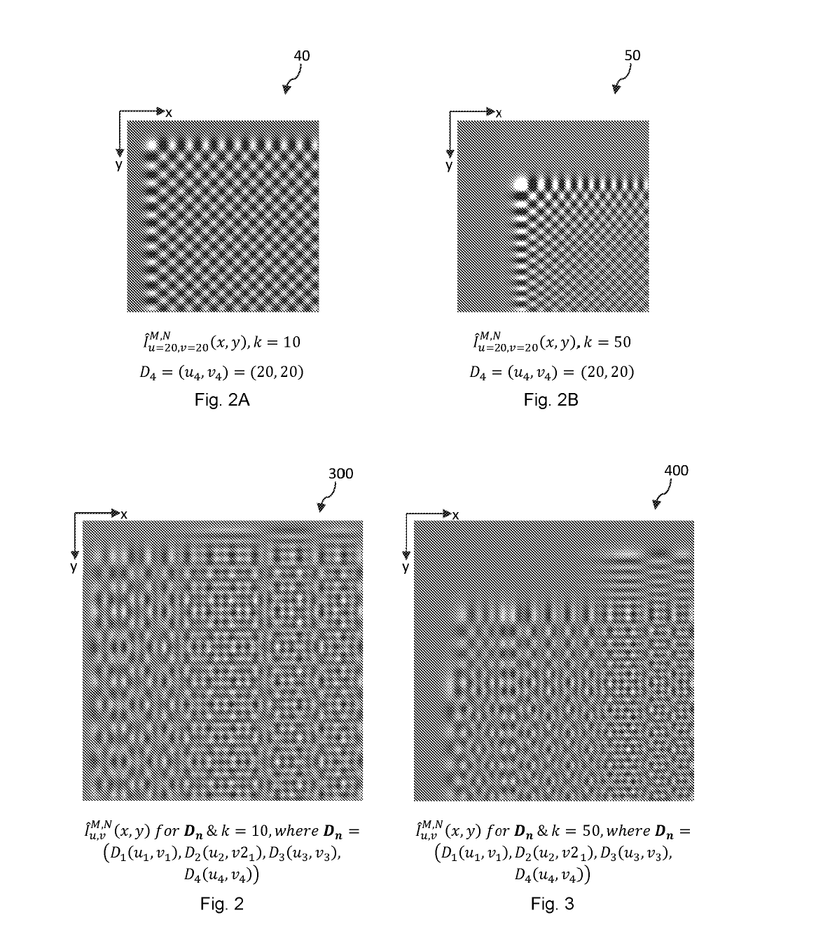

In another example, the set of data D further comprises another discrete data D₄, where D₄=(u₄,v₄)=(20,20). The data bearing pattern 300 having the expression Î_{u,v}^{M,N}(x,y) as depicted in FIG. 2 is due to the sum of the four corresponding expressions of the individual data, namely, D₁, D₂, D₃, and D₄ without loss of generality.

Where the set of data D comprises a single discrete data D₄, the spatial representation of the data bearing pattern Î_{u,v}^{M,N}(x,y) will become Î_{u4,v4}^{M,N}(x,y)=Î_{20,20}^{M,N}(x,y) and the unique corresponding representation will be in the form of

$${G}_{k}^{20 , 20} ( x , y ) {J}_{k} ( \frac{{α}_{k , 20} {α}_{k , x}}{{α}_{k , 257}} ) {J}_{k} ( \frac{{α}_{k , 20} {α}_{k , y}}{{α}_{k , 257}} ) .$$

When the order k is 10, the data bearing pattern will be as depicted in FIG. 2A. As depicted in FIG. 2B, when the order k is changed to 50, the data bearing pattern will have its appearance changed even though the data remains the same as D₄(20,20).

Where k is changed to 50, the data bearing pattern 400 for the set of discrete data D₁, D₂, D₃, and D₄ is as depicted in FIG. 3, showing a different set of spatial distribution properties.

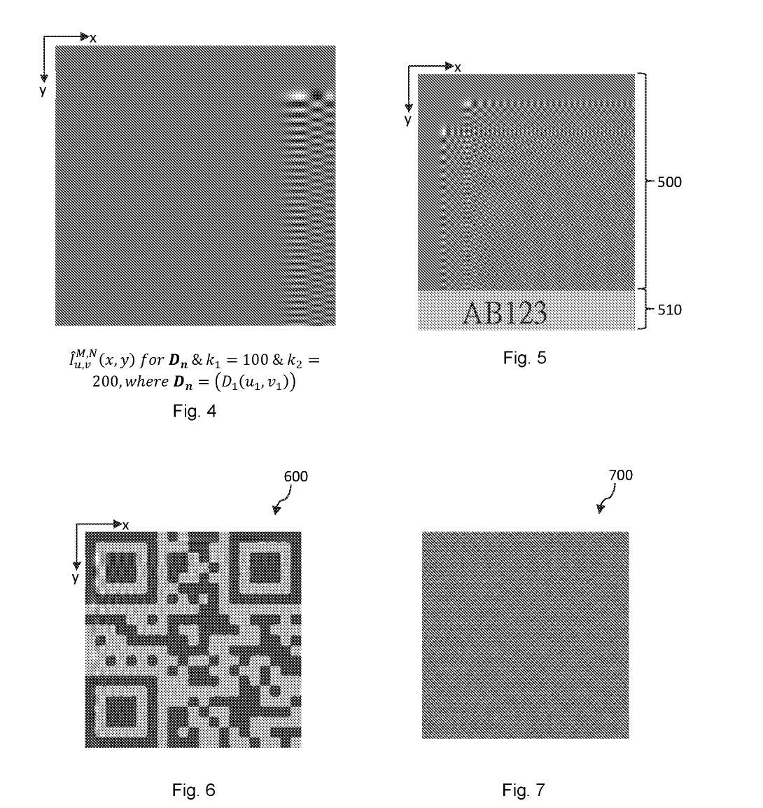

In the example information bearing device as depicted in FIG. 4, the example data bearing pattern is obtained by processing data D₁ with k₁=100 and k₂=200.

Where an image pattern has a resolution of (N×M) pixel elements arranged into N rows and M columns, the image pattern can have a total of N×M×L number of possible pattern variations, where L is the possible variation of each pixel element. For an image pattern of (N×M) pixel elements where each pixel element has a maximum variations of 256 grey scale levels, namely, from 0 to 255, L=256.

From the equation Î_{u,v}^{M,N}(x,y)=Σᵤ₌₁^{M}Σᵥ₌₁^{N}(x,y){ΣᵢDᵢ(u,v)} above, it will be noted that the function βₖ^{u,v}(x,y) comprises a plurality of relation functions βₖ^{u}^{ᵢ}^{,v}^{ᵢ}(x,y), where 1≦uᵢ≦M and 1≦vᵢ≦N. Each of the relation functions βₖ^{u}^{ᵢ}^{v}^{ᵢ}(x,y) has the effect of spreading or scattering a discrete data (uᵢ,v₁) into an image pattern of (N×M) pixel elements the spatial distribution characteristic of which is characteristic of the discrete data (uᵢ,v₁) and the specific relation function βₖ^{u}^{ᵢ}^{,v}^{ᵢ}(x,y). As there are a total of N×M relation functions βₖ^{u}^{ᵢ}^{,v}^{ᵢ}(x,y), a maximum of N×M discrete data can be represented by an image pattern of (N×M) pixel elements where each of the relation functions βₖ^{u}^{ᵢ}^{,v}^{ᵢ}(x,y) is unique. Even if the relation functions are known, recovery or reverse identification of the actual data still require a correct key k.

A captured image of an example information bearing device formed on a printed tag is depicted in FIG. 5. The example information bearing device comprises an example data bearing pattern 500 and a set of key information bearing device 510. The data bearing pattern 500 was previously processed by the transformation process of E120 to convert a set of discrete data into the data bearing pattern 500 which carries a set of spatial distribution properties that is characteristic of the set of discrete data. The key information bearing device 510 comprises the set of image corresponding to ‘AB123’ which is printed underneath the data bearing pattern 500. To retrieve data embedded in the data bearing pattern 500, the message ‘AB123’ is recovered from the image, for example, by optical character recognition, and the related parameter (k) will be retrieved, for example, from databases relating the message to the parameter (k) as depicted in the table below.

TABLE 1

| | Message | | | | |
|---|---|---|---|---|---|
| | 111 | 110 | 101 | AB123 | . . . |
| Parameter (k) | 100 | 51 | 312 | 100 | . . . |

The data bearing pattern 500 is resized into M×N pixels and reverse transformation process E140 is performed on the resized image to recover the set of data.

A captured image of an example information bearing device formed on a printed tag is depicted in FIG. 6. The example information bearing device comprises an example data bearing pattern 600 and a set of key information bearing device. The data bearing pattern 600 was previously processed by the transformation process of E120 to convert a set of discrete data into the data bearing pattern 600 which carries a set of spatial distribution properties that is characteristic of the set of discrete data. The key information bearing device comprises a set of key data ‘111’ which was also encoded on the information bearing device, albeit using a different coding scheme. In this example, the key data ‘111’ was encoded in a format known as ‘QR’™ code.

To retrieve data embedded in the data bearing pattern 600, the message ‘111’ is recovered from the image, and the related parameter (k) will be retrieved, for example, from databases relating the message to the parameter (k) as depicted in Table 1 above.

Likewise, the data bearing pattern 600 is resized into M×N pixels and reverse transformation process E140 is performed on the resized image to recover the set of data.

A captured image of an example information bearing device formed on a printed tag is depicted in FIG. 7. The example information bearing device comprises an example data bearing pattern 700 and a set of key information bearing device. The data bearing pattern 700 was previously processed by the transformation process of E120 to convert a set of discrete data into the data bearing pattern 700 which carries a set of spatial distribution properties that is characteristic of the set of discrete data. The key information bearing device comprises a set of key parameter ‘111’ which was also encoded on the information bearing device, albeit using a Fourier coding scheme.

To recover the key parameter, inverse Fourier transform is performed and the key parameter thus obtained is utilised to recover the set of discrete data after resizing the information bearing pattern 700 into M×N pixels and then to perform the reverse transformation process E140.

In the above examples, Bessel function of the first kind is used as it has an effect of spreading a discrete data into a set of distributed image elements such as a set of continuously distributed image elements as depicted in FIGS. 1A to 2B. Another advantage of the Bessel function is its key dependence, so that the amplitude intensity distribution is variable and dependent on a key k.

While Bessel function of the first kind has been used as example above, it would be appreciated that other functions that can spread a discrete data point into a set of distributed image elements and the characteristics of the set of distributed image elements can be further carried by a preselected key would also be suitable. Hankel function and Riccati-Bessel function etc. are other suitable examples to form transformation functions.

While the term ‘spread’ has been used in this disclosure since the effect of the transformation is akin to the function of a ‘point spreading function’, such a term has been used in a non-limiting manner to mean that a discrete data is transformed into a set of distributed image elements. In general, a suitable transformation function would be one that could operate to represent a discrete data symbol such as data symbols (uᵢ,vᵢ) above with information or coding spread in the spatial domain. While spreading functions having aperiodic properties in their spatial domain distribution or spread have been described above, it would be understood by persons skilled in the art that functions having periodic properties in their spatial domain distribution or spread that are operable with a key for coding would also be used without loss of generality.

1-22. (canceled)

23. An information bearing device comprising a data bearing pattern, the data bearing pattern comprising M×N pattern defining elements which are arranged to define a set of characteristic spatial distribution properties (Î_{u,v}^{M,N}(x,y)), wherein the set of data comprises at least one discrete data (rᵢ,vᵢ), and said discrete data has an associated data bearing pattern which is characteristic of said discrete data, wherein said discrete data and the associated data bearing pattern of said discrete data is related by a characteristic relation function (βₖ_{₂}_{,k}_{₂}^{u}^{ᵢ}^{,v}^{ᵢ}(x,y)), the characteristic relation function defining spatial distribution properties of said associated data bearing pattern according to said discrete data (uᵢ,vᵢ) and a characteristic parameter (k) that is independent of said discrete data.

24. An information bearing device according to claim 23, wherein the set of data comprises a plurality of discrete data and each said discrete data (uᵢ,vᵢ) has an associated data bearing pattern which is characteristic of said discrete data, and the set of characteristic spatial distribution properties is due to the associated data bearing patterns of said plurality of discrete data.

25. An information bearing device according to claim 23, wherein the data bearing pattern comprises pattern defining elements arranged into M rows along a first spatial direction (x) and N columns along a second spatial direction (y), and the relation function (βₖ_{₂}_{,k}_{₂}^{u}^{ᵢ}^{,v}^{ᵢ}(x,y)) has a monotonous trend of change of spatial distribution properties in each spatial direction.

26. An information bearing device according to claim 23, wherein the set of data comprises a plurality of discrete data and the relation functions ([βₖ^{u,v}(x,y)]) of said plurality of discrete data are linearly independent.

27. A method of forming an information bearing device, the information bearing device comprising a data bearing pattern having a set of characteristic spatial distribution properties (Î_{u,v}^{M,N}(x,y)), wherein the method comprises:—
processing a set of data comprising a plurality of discrete data by a corresponding plurality of relation functions ([βₖ^{u,v}(x,y)]) to form the data bearing pattern, wherein the relation functions are linearly independent and each relation function (βₖ_{₁}_{,k}_{₂}^{u}^{ᵢ}^{,v}^{ᵢ}(x,y)) relates a discrete data (uᵢ,vᵢ) to an data bearing pattern having a set of spatial distribution properties characteristic of said discrete data, and
wherein spatial distribution characteristics of said data bearing pattern is dependent on a characteristic parameter that is independent of said discrete data.

28. A method according to claim 27, wherein the data bearing pattern comprises M×N pattern defining elements and the method comprises including a maximum of M×N relation functions [βₖ^{u,v}(x,y)] to define a maximum of M×N data bearing patterns to form said data bearing pattern, wherein each one of said the M×N data bearing patterns has a set of characteristic spatial distribution properties that is specific to said discrete data (uᵢ,vᵢ).

29. An information bearing device according to claim 23, wherein said relation function βₖ_{₁}^{u}^{ᵢ}^{,v}^{ᵢ}(x,y), comprises a first elementary relation function εₖ_{₁}^{u}^{ᵢ}(x) and a second elementary relation function εₖ_{₂}^{v}^{ᵢ}(y), and wherein the first elementary relation function εₖ_{₁}^{u}^{ᵢ}(x) is to relate a first component uᵢ of a discrete data in a first data domain to a set of spatial distribution properties in a first spatial domain (x) according to a first characteristic parameter component k₁, and the second elementary relation function εₖ_{₂}^{v}^{ᵢ}(y) is to relate a second component vᵢ of the discrete data (uᵢ,vᵢ) in a second data domain orthogonal to the first data domain to a set of spatial distribution properties in a second spatial domain (y) orthogonal to the first spatial domain according to a second characteristic parameter component k₂.

30. An information bearing device according to claim 29, wherein the first characteristic parameter component k₁ and the second characteristic parameter component k₂ are equal.

31. An information bearing device according to claim 24, wherein the data bearing pattern comprises pattern defining elements arranged into M rows along a first spatial direction (x) and N columns along a second spatial direction (y), wherein the relation function βₖ_{₁}_{,k}_{₂}^{u,v}(x,y) is express-able as a product of first and second elementary relation functions (εₖ_{₁}^{u}(x)εₖ_{₂}^{v}(y)), k₁, k₂ being orders of the elementary relation functions (εₖ_{₁}^{u}(x)&εₖ_{₂}^{v}(y)).

32. An information bearing device according to claim 31, wherein α₁εₖ_{₁}^{u=1}(x)+α₂εₖ_{₁}^{u=1}(x)+ . . . +α_{M}εₖ_{ₛ}^{u=M}(x)=0 if and only if α₁=α₂= . . . =α_{M}=0.

33. An information bearing device according to claim 31, wherein α₁εₖ_{₂}^{v=1}(y)+α₂εₖ_{₂}^{v=1}(y)+ . . . +α₈εₖ_{₂}^{v=M}(y)=0 if and only if α₁=α₂= . . . =α_{N}=0.

34. An information bearing device according to claim 31, wherein
$${\sum }_{u = 1}^{M} {ɛ}_{{k}_{1}}^{u} ( x ) {ɛ}_{{k}_{1}}^{u} ( {x}^{′} ) = \{ \begin{matrix}1 & if x = {x}^{′} \\ 0 & if x \neq {x}^{′}\end{matrix}$$

35. An information bearing device according to claim 31, where the first elementary relation function is in the form of
$${ɛ}_{{k}_{1}}^{u} ( x ) = \frac{2 {J}_{{k}_{1}} ( \frac{{α}_{{k}_{1} , u} {α}_{{k}_{1} , x}}{{α}_{{k}_{1} , M}} )}{{α}_{{k}_{1} , M} \vert {J}_{{k}_{1} + 1} ( {α}_{{k}_{1} , u} ) \vert \vert {J}_{{k}_{1} + 1} ( {α}_{{k}_{1} , x} ) \vert} ,$$
and the second elementary relation function is in the form of
$${ɛ}_{{k}_{2}}^{u} ( y ) = \frac{2 {J}_{{k}_{2}} ( \frac{{α}_{{k}_{2} , v} {α}_{{k}_{2} , y}}{{α}_{{k}_{2} , N}} )}{{α}_{{k}_{2} , N} \vert {J}_{{k}_{2} + 1} ( {α}_{{k}_{2} , v} ) \vert \vert {J}_{{k}_{2} + 1} ( {α}_{{k}_{2} , y} ) \vert} ,$$

36. An information bearing device according to claim 23, wherein the relation function βₖ_{₁}_{,k}_{₂}^{u,v}(x,y) is representable by an expression of the form:
$$\frac{4}{{α}_{k 1 , M + 1} {α}_{k 2 , N + 1}} \frac{{J}_{{k}_{1}} ( \frac{{α}_{k 1 , u} {α}_{k 1 , x}}{{α}_{k 1 , M + 1}} ) {J}_{{k}_{2}} ( \frac{{α}_{k 2 , v} {α}_{k 2 , y}}{{α}_{k 2 , N + 1}} )}{\vert {J}_{k 1 + 1} ( {α}_{k 1 , u} ) \vert \vert {J}_{k 1 + 1} ( {α}_{k 1 , x} ) \vert \vert {J}_{k 2 + 1} ( {α}_{k 1 , v} ) \vert \vert {J}_{k 2 + 1} ( {α}_{k 2 , y} ) \vert} ,$$
where k₁, k₂ are keys to the relation function βₖ_{₁}_{,k}_{₂}^{u,v}(x,y).

37. An information bearing device according to claim 23, wherein k₁=k₂=k₃, and the relation function βₖ^{u,v}(x,y) is representable by an expression of the form
$$\frac{4}{{α}_{k , M + 1} {α}_{k , N + 1}} \frac{{J}_{k} ( \frac{{α}_{k , u} {α}_{k , x}}{{α}_{k , M + 1}} ) {J}_{k} ( \frac{{α}_{k , v} {α}_{k , y}}{{α}_{k , N + 1}} )}{\vert {J}_{k + 1} ( {α}_{k , u} ) \vert \vert {J}_{k + 1} ( {α}_{k , x} ) \vert \vert {J}_{k + 1} ( {α}_{k , v} ) \vert \vert {J}_{k + 1} ( {α}_{k , y} ) \vert} ,$$
wherein k is a key to the relation function βₖ^{u,v}(x,y).

38. An information bearing device according to claim 36, wherein Σᵤ₌ₜ^{M}Σᵥ₌₁^{N}α_{u,v}βₖ^{u,v}(x,y)=0 if and only if α_{1,2}−α_{1,2}− . . . −α_{M,N}−0.

39. An information bearing device according to claim 36, wherein
$${\sum }_{u = 1}^{M} {\sum }_{v = 1}^{N} {β}_{k}^{u , v} ( x , y ) {β}_{k}^{u , v} ( {x}^{′} , {y}^{′} ) = \{ \begin{matrix}1 & if x = {x}^{′} and y = {y}^{′} \\ 0 & otherwise\end{matrix}$$

40. An information bearing device according to claim 23, wherein the set of data Î_{x,y}^{M,N}(u,v) and the spatial representation Î_{u,v}^{M,N}(x,y) are related by an expression of the form Î_{x,y}^{M,N}(u,v)= [symbol] (u,x)Î_{u,v}^{M,N}(x,y) [symbol] (y,v), where:
$$( u , x ) = [ \begin{matrix}{ɛ}_{k} ( u = 1 , x = 1 ) & ⋯ & {ɛ}_{k} ( u = 1 , x = M ) \\ ⋮ & ⋱ & ⋮ \\ {ɛ}_{k} ( u = M , x = 1 ) & ⋯ & {ɛ}_{k} ( u = M , x = M )\end{matrix} ] , and$$
$$( v , y ) = [ \begin{matrix}{ɛ}_{k} ( v = 1 , y = 1 ) & ⋯ & {ɛ}_{k} ( v = 1 , y = N ) \\ ⋮ & ⋱ & ⋮ \\ {ɛ}_{k} ( v = N , y = 1 ) & ⋯ & {ɛ}_{k} ( v = N , y = N )\end{matrix} ] .$$

41. An information bearing device according to claim 23, wherein
$${c}_{1} ( \begin{matrix}{ɛ}_{k} ( 1 , 1 ) \\ ⋮ \\ {ɛ}_{k} ( M , 1 )\end{matrix} ) + {c}_{2} ( \begin{matrix}{ɛ}_{k} ( 1 , 2 ) \\ ⋮ \\ {ɛ}_{k} ( M , 2 )\end{matrix} ) + … + {c}_{M - 1} ( \begin{matrix}{ɛ}_{k} ( 1 , M ) \\ ⋮ \\ {ɛ}_{k} ( M , M )\end{matrix} ) = 0$$
if and only if c₁=c₂= . . . =c_{M}=0.

42. An authentication device comprising an information bearing device, wherein the information devices comprises a data bearing pattern, the data bearing pattern comprising M×N pattern defining elements which are arranged to define a set of characteristic spatial distribution properties (Î_{u,v}^{M,N}(x,y)), wherein the set of data comprises at least one discrete data (uᵢ,vᵢ), and said discrete data has an associated data bearing pattern which is characteristic of said discrete data, wherein said discrete data and the associated data bearing pattern of said discrete data is related by a characteristic relation function (βₖ_{ₓ}_{,k}_{₂}^{u}^{ᵢ}^{,v}^{ᵢ}(x,y)), the characteristic relation function defining spatial distribution properties of said associated data bearing pattern according to said discrete data (uⁱ,vⁱ) and a characteristic parameter (k) that is independent of said discrete data.

43. An authentication device according to claim 42, wherein the relation function comprises a two-dimensional Bessel function of order k.

44. An authentication device according to claim 43, further including information relating to said characteristic parameter (k).
